(19) United States
(12) Patent Application Publication
(10) Pub. No.: US 2010/0276376 A1
(43) Pub. Date: Nov. 4, 2010

(54) METHOD FOR DETERMINING THE EXHAUSTION OF A FILTER CARTRIDGE IN A FILTER SYSTEM WITH REPLACEABLE CARTRIDGE AND DEVICE OPERATING ACCORDING TO THAT METHOD

(76) Inventor: Maurizio Moretto, Vicenza (IT)

Correspondence Address: CASTELLANO PLLC, P.O. Box 1555, Great Falls, VA, 22066, US

(21) Appl. No.: 12/811,840

(22) PCT Filed: Feb. 7, 2008
(86) PCT No.: PCT/IT08/00079

§ 371 Date: Jul. 7, 2010

(30) Foreign Application Priority Data
Jan. 15, 2008 (IT) PD2008A000013

(51) Int. Cl. B01D 35/143; C02F 1/00

(52) U.S. Cl. 210/739; 210/85

(57) ABSTRACT

For determining the exhaustion of a filter cartridge (8) according to the time elapsed since its activation, by means of a timer (15) and a control unit (16) associated therewith an operating time (TO) of useful life of the cartridge is calculated starting from its activation, and the calculating of a pause time (TP) is activated according to each pause in use of the cartridge (8) during the operating time (TO) in order to incorporate the calculating of the operating time with a recovery time determined according to the pause time (TP) calculated.

### TECHNOLOGICAL BACKGROUND

In filter systems with replaceable cartridge, and in particular in filter jugs for making water drinkable for domestic use, it is known for example from EP0891952 and EP0955268 to use methods for indicating the exhaustion of the filter cartridge that are based on the time the cartridge has been in use, calculated from its initial activation. It is equally known to base the detection of the state of exhaustion of the filter cartridge on the time it has been in use, mediated by the quantity of water treated, this second parameter being determined on the basis of the number of filling cycles of the jug during the time in question.

In each case, when the criterion used for determining the state of exhaustion of the cartridge is based on the duration (time) of use of same, statistical simplifications are employed, assuming, for example, as a statistical basis, that a normal user uses the jug periodically (e.g. daily or monthly) for a predetermined number of cycles. This helps to define reasonably approximately the time after which the cartridge in use should be replaced with a new one.

In the normal course of daily life, however, fairly significant periods of “non-use” of the filter system may occur, and this substantially alters the reliability of the criteria for determining the exhaustion of the cartridge that are based on the time elapsed since the initial activation.

A long interval of non-use of the jug, such as, for example, during a holiday, or due to prolonged absence, a journey, etc. exposes the consumer to two possible drawbacks:

1) the useful life of the cartridge is artificially shortened inasmuch as, during the absence, although not using the filter system, the calculation of the exhaustion time of same proceeds without interruption, or
2) the consumer may be induced to “compensate” for such an interruption in the use of the filter system by means of an extension of the time of use of the same cartridge, beyond the indicated expiry time, which extension is very often purely arbitrary and devoid of any real connection with the true interruption time.

### TECHNICAL PROBLEM

The problem underlying the present invention is that of providing a method and a device, for determining the exhaustion of a filter cartridge in filter jugs with replaceable cartridge, structurally and functionally designed so as to be free of the drawbacks mentioned with reference to the prior art cited. Within the framework of this problem, it is a principal aim of the invention to provide a device which makes it possible to take account of interruptions in the use of the jug without leaving the corresponding calculation to chance.

Another aim of the invention is that of obtaining the aforesaid result completely automatically and without direction intervention on the part of the user.

### DESCRIPTION OF INVENTION

This problem is solved and these aims are achieved by the invention by means of a method and a device for determining the exhaustion of a filter cartridge in filter jugs with replaceable cartridge produced according to the following claims.

In practice, the invention is based on the fact of extending the useful life of the cartridge to an extent proportional to the duration of any pauses in use of same, during the operating time thereof, by adding a recovery time determined according to the pause time calculated.

### BRIEF DESCRIPTION OF THE DRAWINGS

The characteristics and advantages of the invention will become clearer from the following detailed description of a preferred exemplary embodiment thereof, illustrated by way of non-limiting example with reference to the appended drawings, in which:

FIG. 1 is a diagrammatic view in longitudinal section of a jug filter system including a device according to the invention;

FIG. 2 is a plan view from above of the system of FIG. 1;

FIG. 3 is a view of the system of FIG. 2 with the lid removed;

FIG. 4 is a diagrammatic plan view of the device of the present invention.

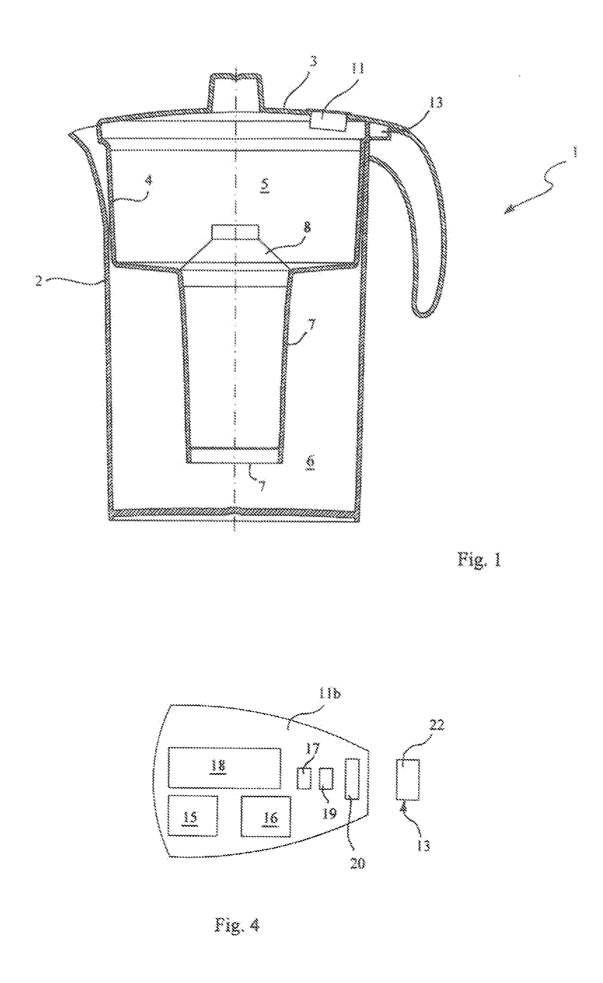

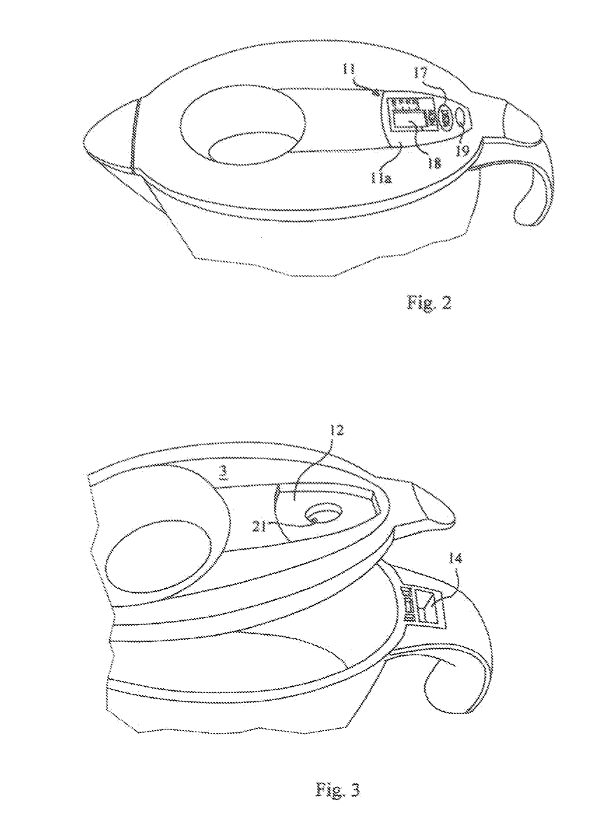

### PREFERRED EMBODIMENTS OF THE INVENTION

In the drawings, the reference 1 indicates as a whole a filter system with replaceable cartridge for making water drinkable for domestic use. The system shown by way of example is of the type with a jug 2, the mouth of which is removably closed by a lid 3. The invention is furthermore applicable to different systems such as kettles, cafeterias, in-line filters and the like. The jug 2 is provided on the inside with a funnel-shaped divider (hopper) 4 which defines a first receiving reservoir 5 for the water to be filtered, communicating with a second receiving reservoir 6 for the filtered water via a pipe 7. The removable filter cartridge 8 is housed in the pipe 7 in such a way that the water which flows by gravity from the reservoir 5 to the reservoir 6 necessarily passes through the filter material contained in the cartridge 8.

The filtering capacity of the cartridge 8 is subject to decay depending on the time elapsed since its initial activation, besides the increase in the quantity of water filtered, and it is therefore advisable to monitor the time elapsed since the initial activation of the cartridge in order to suggest to the user that it is replaced when a predetermined operating time TO has elapsed.

With this aim, a device for determining the exhaustion of the cartridge 8 is provided which comprises a first element 11 housed in a seat 12 of the lid and a second element 13 housed in a seat 14 provided in the handle of the jug 2. The arrangement is such that when the lid 3 is placed in its normal position of use on the mouth of the jug 2, the two elements 11, 13 are located next to each other, in the mutual radius of action (as will be explained hereinafter) while when the lid 3 is removed from the jug 2 the two elements 11, 13 are moved away from each other. The first element 11 comprises a box-like enclosure 11a which contains and supports an electronic circuit 11b including a timer 15 and a control unit 16 which is associated with the timer in a manner known per se for calculating an operating time of useful life of the cartridge starting from activation thereof and for the purpose of indicating the exhaustion thereof. Preferably, the first element is equipped with an actuating push-button 17 and with an indicator/display 18 suitable for visually indicating the time elapsed since the initial activation and/or for visually and/or acoustically indicating the approach of the expiry of the recommended operating time TO within which the cartridge in use is to be replaced.

The electronic circuit 11b further comprises means for calculating a pause time and which can be actuated in conditions of a pause in the use of the cartridge. Such calculating means are preferably incorporated in the control unit 16 itself and are activated in the calculating of the pause time or manually by the user, for example via a second push-button 19 associated with the circuit 11b. In a preferred alternative, the calculating means are activated automatically via the interaction between a switch 20, for example of the reed type, associated with the circuit 11b and a magnet 22 or another operational actuating device of the switch 20, housed on the seat 14 to constitute the second element 13.

In this way, when the lid is fitted onto the jug in the normal operating position the switch 20 is subjected to the magnetic field of the magnet 22 and is set by this latter into a first position such that the circuit 11b, if activated, proceeds to calculate the operating time TO. When, however, the lid 3 is removed from the jug 2, the switch 20 is removed from the radius of action of the magnet 22 and is therefore set into a second position such that there is set in motion in the circuit 11b the calculating of a pause time TP which will terminate as soon as the lid 3 is again positioned on the mouth of the jug 2. The calculating is carried out by the same timer 15 and control unit 16 which control the calculating of the operating time.

In practice, the state of proximity between the first and the second element generates, by means of the interaction between the switch 20 and the magnet 22, a signal of consent to the calculating of the operating time TO and/or to the activation of the calculating means of same.

The pause time TP is then compared, by means of software contained in the control unit 16, to a preset minimum threshold value T1 and to a preset maximum threshold value T2. If the duration of the pause time TP is less than the threshold value T1 (brief pause) the calculation of the operating time is not influenced by the duration of the pause. This serves to exclude the influence of casual removal of the lid or of deliberate removal for the purpose of cleaning or normal maintenance of the jug.

Equally, if the duration of the pause time TP is greater than the threshold value T2 (very long pause) the calculation of the operating time is not influenced by the duration of the pause. This means that the period of inactivity of the cartridge 8 has a duration such as to prejudice or in any case no longer ensure that the cartridge can be reused with a reasonable degree of safety after the expiry of the “normal” operating time.

If however the pause time TP has lasted between the threshold values T1 and T2 a pause of the “recoverable” type will be occurring and the control unit will proceed to incorporate the calculating of the operating time (temporarily suspended) with a recovery time TR determined according to the pause time calculated. The function may be selected as desired, according to a linear course (recovery time=to pause time) or differentiated course (TR=f(TP)).

The recovery time will be added to the allowable operating time, where the corresponding calculating is continued during the pause, or subtracted from the calculated operating time, where the corresponding calculating continues during the pause.

In all cases, the allowable duration of the cartridge will be increased according to the duration of the pause time according to the criteria indicated.

In a variant to the solution proposed, the software contained in the control unit 16 may perform one or more of the following functions:

simple activation of the timer and/or of the control unit associated to therewith depending on the presence of the consent signal;

activation of the normal calculating activity in the presence of the consent signal and suspension of that activity in the absence of same;

activation of the normal calculating activity in the presence of the consent signal and alteration of that activity in the absence of same. The alteration leads however to partial or total compensation of the pause time by means of a correction factor correlated thereto: for example, the pause time may assume a fractional value (for example halved) for the purpose of calculating the exhaustion time of the cartridge.

Alternatively, in the example proposed, provision is also made that instead of moving the lid away from the jug it is possible to move away only the first element 11 from its seat 12. For this reason, provision is made for the element 11 to be removably inserted into the seat 12 and for the latter to be optionally provided in its bottom surface with a through-hole 21 which serves for exerting a pressure on the enclosure 11a in order to extract it from the seat 12. The extraction of the element 11 from the seat 12 further serves for maintenance purposes, such as the replacement of the supply battery for the first element 11.

As a further alternative to the removal of the lid and/or of the element 11, provision is also made for the removal of the magnet 22 from the seat 14.

Finally, provision is made for one or both of the elements 11 and 13, preferably including that containing the timer and the display, to be housed in the handle of the jug, preferably in the upper part of same, or in the hopper or yet another part of the filter system, while remaining provided for to by the present invention.

The invention thus achieves the aims proposed, in a simple and effective manner, permitting optimum use of the filter cartridges in full with respect to the parameters of safety and guarantee for the user.

1. A method for determining the exhaustion of a filter cartridge in a filter system with a cartridge replaceable according to the time elapsed since its activation, comprising the following steps:
calculating an operating time (TO) of useful life of the cartridge starting from its activation by means of a timer and a control unit,
further comprising the steps of
calculating a pause time (TP) function of each pause in the use of the cartridge during said operating time (TO),
calculating a recovery time (TR) function of said pause time (TP), and
modifying said operating time (TO) incorporating said recovery time (TR) in order to take into account the time in which the cartridge has not been used.

2. The method for determining the exhaustion of a filter cartridge according to claim 1, wherein the calculating of the pause time (TP) is activated automatically each time at least two components of the filter system that are intended for the activation of said calculation are moved away from one another.

3. The method for determining the exhaustion of a filter cartridge according to claim 2, wherein the filter system is of the filter jug type removably closed by a lid and one of said at least two components includes said lid.

4. The method for determining the exhaustion of a filter cartridge according to claim 2, wherein one of said two components comprises a switch and the other of said components comprises an actuator for said switch.

5. The method for determining the exhaustion of a filter cartridge according to claim 4, wherein said switch is of the magnetically actuated type and said actuator is of the magnetic type.

6. The method according to claim 5, further comprising the step of generating a signal of consent for calculating the operating time (TO) by means of interaction between the switch and the magnet.

7. The method according to claim 6, wherein, in the absence of said consent signal, the operational functioning of the timer in the function of calculating the operating time (TO) is modified by a correction factor correlated to the pause time (TP).

8. The method for determining the exhaustion of a filter cartridge according to claim 1, comprising a step of comparing the pause time (TP) with at least a maximum threshold value (T2), beyond which the recovery time (TR) is zero.

9. The method for determining the exhaustion of a filter cartridge according to claim 1, comprising a step of comparing the pause time (TP) with at least a minimum threshold value (T1), below which the recovery time (TR) is zero.

10. The method for determining the exhaustion of a filter cartridge according to claim 8, further comprising a step of comparing the pause time (TP) with at least a minimum threshold value (T1), below which the recovery time (TR) is zero,
wherein, if the pause time (TP) is comprised between said maximum (T2) and minimum thresholds (T1), the recovery time (TR) is equal to the pause time (TP).

11. A device for determining the exhaustion of a filter cartridge in a filter system with cartridge replaceable according to the time elapsed since its activation, said device comprising a timer and a control unit associated with the timer for calculating operating time (TO) of useful life of the cartridge starting from activation thereof and for indicating the exhaustion thereof, and further comprising calculating means for calculating a pause time at each pause in the use of the cartridge during said operating time (TO), wherein the calculating means can be activated in conditions of a pause in the use of the cartridge and are operationally connected to the control unit for incorporating in the calculation of the operating time (TO) a recovery time (TR) determined as a function of the pause time (TP) for modifying said operating time (TO) in order to take into account the time in which the cartridge has not been used.

12. The device according to claim 11, wherein the timer and the control unit are contained in a first element of the device, the device further comprising a second element, the state of proximity between the first and the second element generating a signal of consent for calculating the operating time (TO).

13. A device for determining the exhaustion of a filter cartridge in a filter system with replaceable cartridge comprising a timer and a control unit associated with the timer for calculating an operating time (TO) of useful life of the cartridge starting from activation thereof and for the purpose of indicating the exhaustion thereof, calculating means for calculating a pause time (TP) at each pause in the use of the cartridge during said operating time (TO), wherein said timer and/or said control unit are subject to a consent signal and in that at least one of the functions of:
initial activation of the timer, and/or
operational functioning of the timer in the function of calculating the operating time are enabled only in the presence of said consent signal.

14. The device according to claim 13, wherein the consent signal is correlated to means for detecting a state of proximity between at least two components of the filter system that are intended for the activation of said calculating such that said consent signal is interrupted when said at least two components are moved away from one another.

15. A filter system of the filter jug type removably closed by a lid including a device for determining the exhaustion of a filter cartridge according to claim 14 and wherein one of said at least two components includes said lid.

16. The filter system according to claim 15, wherein one of said two components comprises a switch and the other of said components comprises an actuator for said switch.

17. The filter system according to claim 16, wherein said switch is of the magnetically actuated type and said actuator is of the magnetic type.

18. A filter system comprising a jug with a first and a second reservoir for respectively receiving water to be filtered and filtered water and a filter cartridge of the replaceable type removably inserted in a pipe between said reservoirs, comprising a device for determining the exhaustion of the filter cartridge according to claim 11.

19. The filter system according to claim 18, wherein the device is associated with a first element thereof with the lid and with a second element thereof with a part of the jug adjacent to, but structurally independent of, the lid.
